(19) United States
(12) Patent Application Publication
(10) Pub. No.: US 2012/0019639 A1
(43) Pub. Date: Jan. 26, 2012

(54) ACTIVE SHUTTER STEREOSCOPIC IMAGE DISPLAY SYSTEM AND METHOD OF CONTROLLING THE SAME

(75) Inventors: Tao CHANG, New Taipei City (TW); Kuo-Hua LIN, New Taipei City (TW); Horng-Ru WANG, New Taipei City (TW); Kuei-Jen TSAI, Kowloon (TW)

(73) Assignee: TOP VICTORY INVESTMENTS LIMITED, Kowloon (HK)

(21) Appl. No.: 13/187,137

(22) Filed: Jul. 20, 2011

(30) Foreign Application Priority Data
Jul. 21, 2010 (TW) 009123992

(51) Int. Cl. H04N 13/04

(52) U.S. Cl. 348/56; 348/E13.04

(57) ABSTRACT

A stereoscopic image display device is for use with shutter glasses having left and right shutter lenses and includes a display processor, a display screen, a signal generator, and a signal transmitter. The display processor is for receiving a video input signal and outputting a video output signal sequence according to a frame sync signal acquired from the video input signal. The display screen is for receiving the video output signal sequence corresponding to a sequence of left-eye and right-eye images and displays the left-eye and right-eye images in an alternating manner according to the frame sync signal. The signal generator is for generating a shutter sync control signal that is transmitted to the shutter glasses by the signal transmitter for controlling duty cycles of alternating operations of the shutter glasses according to the frame sync signal.

### CROSS-REFERENCE TO RELATED APPLICATION

This application claims priority of Taiwanese Application No. 099123992 filed on Jul. 21, 2010.

### BACKGROUND OF THE INVENTION

1. Field of the Invention

The present invention relates to an image display system and method of controlling the system, more particularly to an active shutter stereoscopic image display system, and method of controlling the stereoscopic image display system.

2. Description of the Related Art

Referring to FIG. 1, a conventional active shutter stereoscopic image display system 1 for 3D viewing includes a stereoscopic image display device 11 and shutter glasses 12 to be worn by a user.

The stereoscopic image display device 11 receives a video signal corresponding to left-eye and right-eye images 101, 102, displays the left-eye and right-eye images 101, 102 in an alternating manner according to a vertical sync signal acquired from the video signal, generates a shutter sync control signal according to the vertical sync signal, and transmits the shutter sync control signal that is synchronized with the vertical sync signal to the shutter glasses 12.

The shutter glasses 12 have left and right shutter lenses 121, 122 that are turned on in an alternating manner according to the shutter sync control signal. The left shutter lens 121 is turned on during display of the left-eye image 101 by the stereoscopic image display device 11, and the right shutter lens 122 is turned on during display of the right-eye image 102 by the stereoscopic image display device 11. Since the left-eye and right-eye images 101, 102 are parallax images, the perceived left and right-eye images 101, 102 present a stereoscopic image in the mind of the user.

However, referring to FIG. 2, the left-eye and right-eye images 101, 102 may overlap for an overlap time (t₀) when switching between the left-eye and right-eye images 101, 102. This can lead to cross-talk and thus affecting adversely 3D viewing by the user.

To reduce the cross talk effect, a black image may be inserted when switching between the left-eye and right-eye images 101, 102. Alternately, backlight source of the stereoscopic image display device 11 may be turned off when switching between the left-eye and right-eye images 101, 102.

Moreover, driving circuits of conventional shutter glasses 12 for turning on and off the left and right shutter lenses 121, 122 are usually not designed to be compatible with vertical sync signals of various display devices of the above mentioned systems.

### SUMMARY OF THE INVENTION

Therefore, an object of the present invention is to provide an active shutter stereoscopic image display system that includes shutter glasses and a stereoscopic image display device used with the shutter glasses. Another object of the present invention is to provide a method of controlling a stereoscopic image display system that includes shutter glasses and a stereoscopic image display device used with the shutter glasses.

Accordingly to an aspect of the present invention, a stereoscopic image display device is adapted for use with shutter glasses having left and right shutter lenses. The stereoscopic image display device comprises:

a display processor for receiving a video input signal and outputting a video output signal sequence according to a frame sync signal acquired from the video input signal;

a display screen electrically connected to the display processor for receiving the video output signal sequence, the video output signal sequence corresponding to a sequence of left-eye and right-eye images, the display screen displaying the left-eye and right-eye images in an alternating manner;

a signal generator electrically connected to the display processor for receiving the frame sync signal and generating a shutter sync control signal according to the frame sync signal, the shutter sync control signal being for, controlling the shutter glasses and including an actuating command for actuating the left and right shutter lenses, first setting information for defining actuating cycles of the left and right shutter lenses, and second setting information for defining duty cycles of alternating operations of the left and right shutter lenses within the actuating cycles; and

a signal transmitter electrically connected to the signal generator for transmitting the shutter sync control signal generated by the signal generator to the shutter glasses.

According to another aspect of the present invention, there is provided shutter glasses adapted for use with a stereoscopic image display device. The stereoscopic image display device is operable to output a shutter sync control signal that includes an actuating command, first setting information, and second setting information. The shutter glasses comprise:

left and right shutter lenses;

a signal receiver adapted for receiving the shutter sync control signal;

a signal processor electrically connected to the signal receiver for receiving and decoding the shutter sync control signal, operable to generate an actuating signal with reference to the actuating command for actuation of the left and right shutter lenses, and operable to generate left and right triggering signals with reference to the first and second setting information for controlling actuating cycles of the left and right shutter lenses and for controlling duty cycles of alternating operations of the left and right shutter lenses within the actuating cycles; and

a shutter driver electrically connected to the signal processor for receiving the left and right triggering signals and for turning on the left and right shutter lenses in an alternating manner based on the left and right triggering signals, respectively.

According to still another aspect of the present invention, there is provided a method of controlling a stereoscopic image display system that includes shutter glasses and a stereoscopic image display device used with the shutter glasses. The stereoscopic image display device receives a video input signal from which a frame sync signal is acquired, and the shutter glasses have left and right shutter lenses. The method comprises:

configuring the stereoscopic image display device to display left-eye and right-eye images of the video input signal in an alternating manner according to the frame sync signal;

configuring the stereoscopic image display device to generate a shutter sync control signal according to the frame sync signal, and to transmit the shutter sync control signal to the shutter glasses for controlling the shutter glasses, the shutter sync control signal including an actuating command for actuating the left and right shutter lenses, first setting information for defining actuating cycles of the left and right shutter lenses, and second setting information for defining duty cycles of alternating operations of the left and right shutter lenses within the actuating cycles; and

configuring the shutter glasses to decode the shutter sync control signal, and to turn on the left and right shutter lenses in an alternating manner with reference to the actuating command and the first and second setting information such that the duty cycle of the left shutter lens corresponds to display of the left-eye image by the stereoscopic image display device and such that the duty cycle of the right shutter lens corresponds to display of the right-eye image by the stereoscopic image display device.

According to yet another aspect of the present invention, there is provided an active shutter stereoscopic image display system comprising:

a stereoscopic image display device including
a display processor for receiving a video input signal and outputting a video output signal sequence according to a frame sync signal acquired from the video input signal,
a display screen electrically connected to the display processor for receiving the video output signal sequence, the video output signal sequence corresponding to a sequence of left-eye and right-eye images, the display screen displaying the left-eye and right-eye images in an alternating manner,
a signal generator electrically connected to the display processor for receiving the frame sync signal and generating a shutter sync control signal according to the frame sync signal, the shutter sync control signal including an actuating command, first setting information, and second setting information, and
a signal transmitter electrically connected to the signal generator for transmitting the shutter sync control signal generated by the signal generator; and

shutter glasses including
left and right shutter lenses,
a signal receiver for receiving the shutter sync control signal from the signal transmitter,
a signal processor electrically connected to the signal receiver for receiving and decoding the shutter sync control signal, operable to generate an actuating signal with reference to the actuating command for actuation of the left and right shutter lenses, and operable to generate left and right triggering signals with reference to the first and second setting information for controlling actuating cycles of the left and right shutter lenses and for controlling duty cycles of alternating operations of the left and right shutter lenses within the actuating cycles, and
a shutter driver electrically connected to the signal processor for receiving the left and right triggering signals and for turning on the left and right shutter lenses in an alternating manner based on the left and right triggering signals, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional shutter stereoscopic image display system;

FIG. 2 illustrates timing sequence of left-eye and right-eye images as controlled by a vertical sync signal;

FIG. 3 is a flow chart of the preferred embodiment of a method of controlling an active shutter stereoscopic image display system according to the pre sent invention;

FIG. 4 is a schematic diagram of the preferred embodiment of an active shutter stereoscopic display system according to the present invention;

FIG. 5 is a schematic block diagram of a stereoscopic image display device of the preferred embodiment;

FIG. 6 is a schematic block diagram of shutter glasses of the preferred embodiment;

FIG. 7 illustrates a shutter sync control signal generated by the stereoscopic image display device of the preferred embodiment;

FIG. 8 illustrates timing sequences of a frame sync signal, the shutter sync control signal, and the shutter sync control signal with a predetermined delay time; and

FIG. 9 illustrates timing sequences of left-eye and right-eye images controlled by the frame sync signal and left and right triggering signals controlled by the shutter sync control signal with the predetermined delay time.

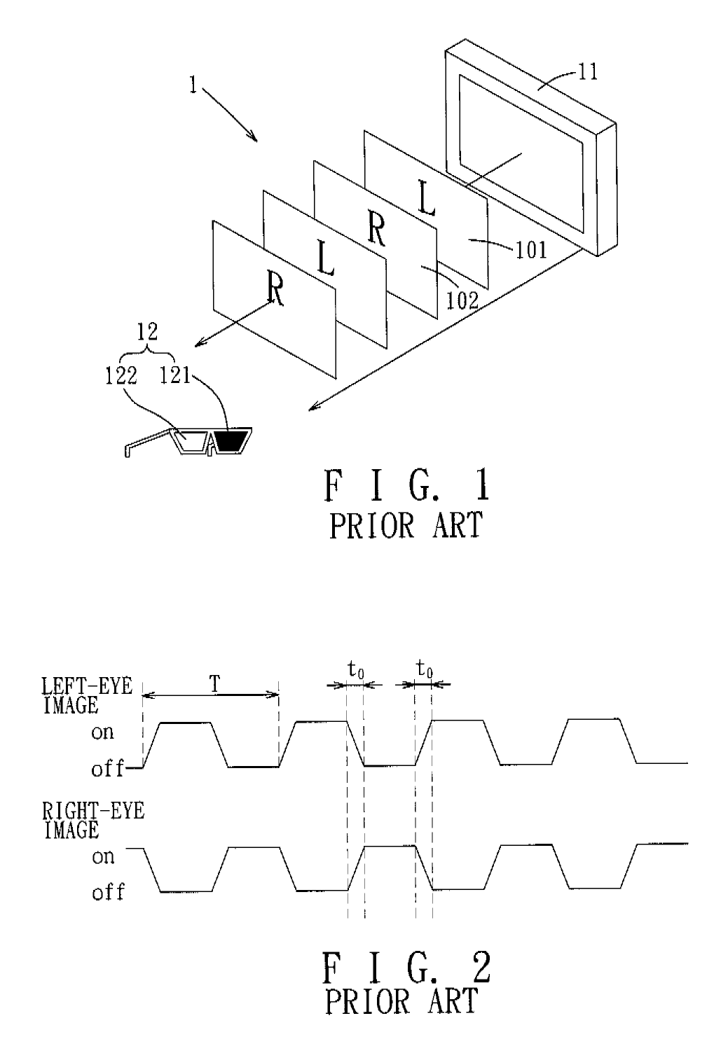

### DETAILED DESCRIPTION OF THE PREFERRED EMBODIMENT

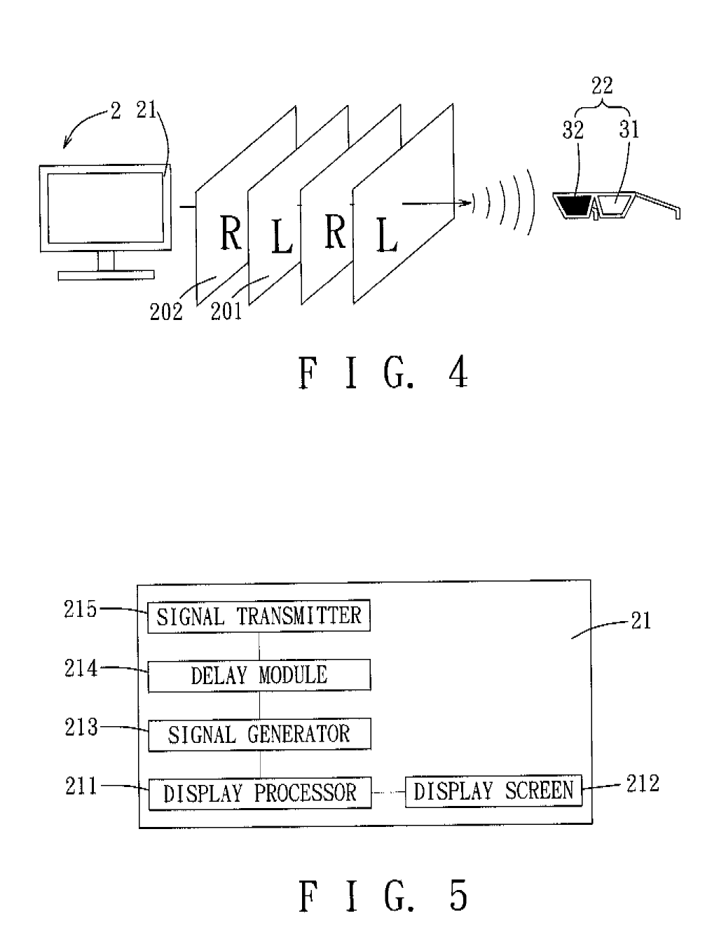

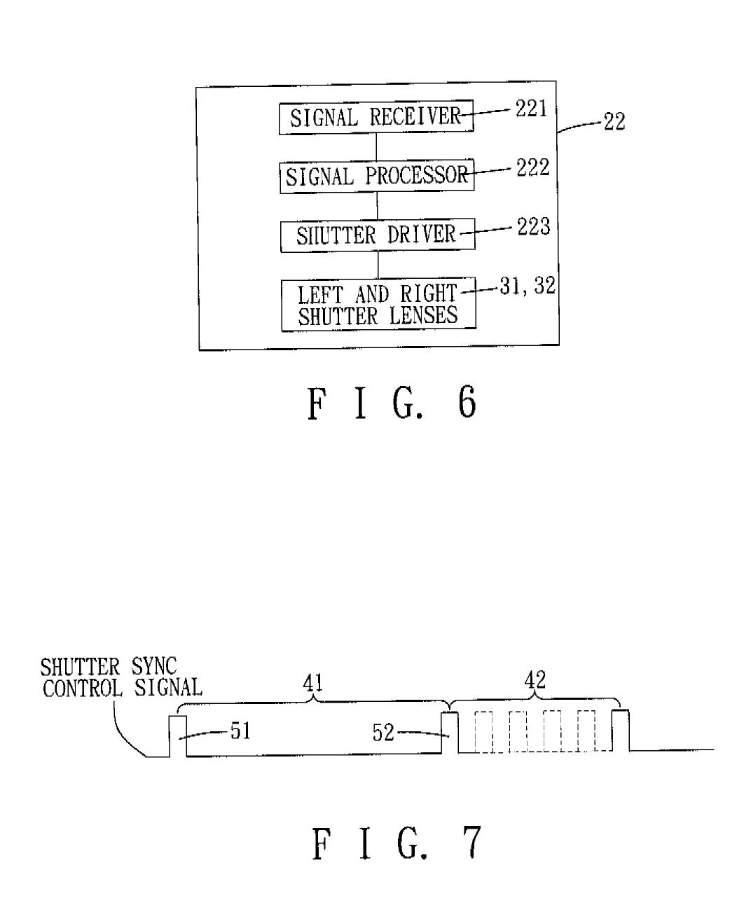

Referring to FIGS. 4 to 6, the preferred embodiment of an active shutter stereoscopic image display system according to the present invention comprises a stereoscopic image display device 21 and shutter glasses 22. In this embodiment, the stereoscopic image display device 21 is a raster scan type TV, and the shutter glasses 22 are liquid crystal shutter glasses.

The stereoscopic image display device 21 includes a display processor 211, a display screen 212, a signal generator 213, a delay module 214, and a signal transmitter 215.

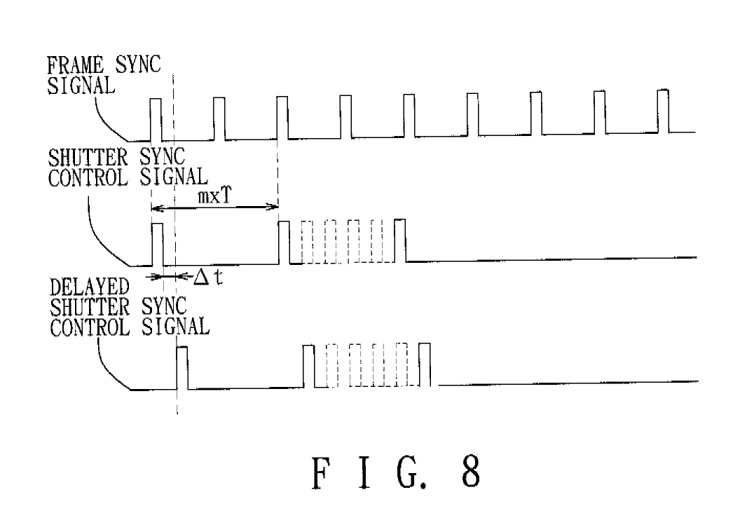

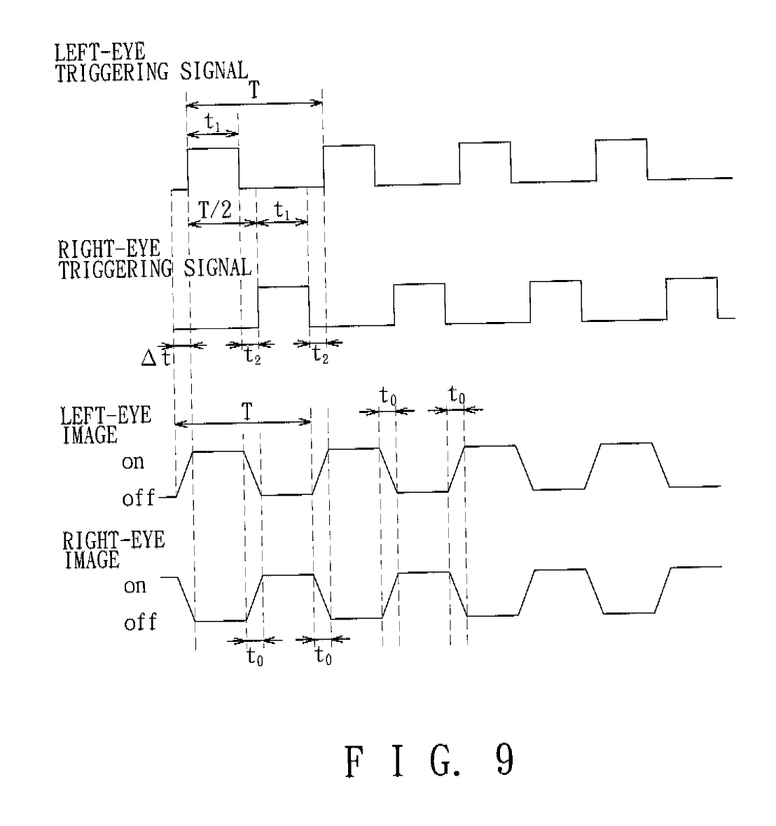

Further referring to FIGS. 7 and 8, the display processor 211 is for receiving a video input signal and outputting a video output signal sequence according to a frame sync signal (e.g., vertical sync signal) acquired from the video input signal. The display screen 212 is electrically connected to the display processor 211 for receiving the video output signal sequence. The video output signal sequence corresponds to a sequence of left-eye and right-eye images 201, 202. The display screen 212 displays the left-eye and right-eye images 201, 202 in an alternating manner. The left-eye and right-eye images 201, 202 are parallax images for presenting a stereoscopic image effect. It is noted that the left and right-eye images 201, 202 may overlap on the display screen 212 for an overlap time (t₀) when switching between the left-eye and right-eye images 201, 202.

The signal generator 213 is electrically connected to the display processor 211 for receiving the frame sync signal and generates a shutter sync control signal according to the frame sync signal. The shutter sync control signal includes an actuating command, first setting information 41, and second setting information 42, which will be described in greater detail hereinafter.

The delay module 214 is electrically connected between the signal generator 213 and the signal transmitter 215. The delay module 214 receives the shutter sync control signal generated by the signal generator 213, introduces a predetermined delay time (Δt) into the shutter sync control signal, and provides the shutter sync control signal with the predetermined delay time (Δt) to the signal transmitter 215 for transmitting the delayed shutter sync control signal to the shutter glasses 22. The predetermined delay time (Δt) is set to compensate for a time difference in operations of the display screen 21 and the shutter glasses 22. In this embodiment, the signal transmitter 215 is a wireless signal transmitter.

The shutter glasses 22 include a signal receiver 221, a signal processor 222, a shutter driver 223, and left and right shutter lenses 31, 32.

The signal receiver 221 is for receiving the shutter sync control signal from the signal transmitter 215. Further referring to FIG. 9, the signal processor 222 is electrically connected to the signal receiver 221 for receiving and decoding the shutter sync control signal, is operable to generate an actuating signal with reference to the actuating command for actuation of the left and right shutter lenses 31, 32, and is operable to generate left and right triggering signals with reference to the first and second setting information 41, 42 for controlling actuating cycles (T) of the left and right shutter lenses 31, 32 and for controlling duty cycles (t₁) of alternating operations of the left and right shutter lenses 31, 32 within the actuating cycles (T). The shutter driver 223 is electrically connected to the signal processor 222 for receiving the left and right triggering signals and for turning on the left and right shutter lenses 31, 32 in an alternating manner based on the left and right triggering signals, respectively. In this embodiment, the signal processor 222 is a decoder.

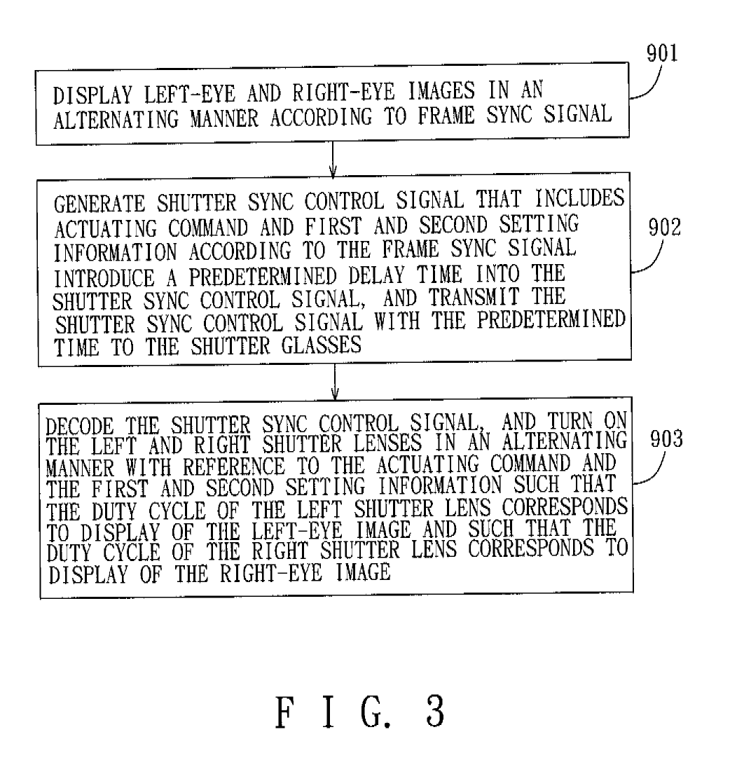

Referring to FIG. 3, the active shutter stereoscopic image display system 2 is configured to implement the preferred embodiment of a method of controlling the stereoscopic image display system 2 including the shutter glasses 22 and the stereoscopic image display device 21. The method includes the following steps.

In step 901, the stereoscopic image display device 21 is configured to display left-eye and right-eye images 201, 202 corresponding to the video output signal sequence in an alternating manner according to the frame sync signal.

In step 902, the stereoscopic image display device 21 is configured to generate a shutter sync control signal according to the frame sync signal, to introduce a predetermined delay time (Δt) into the shutter sync control signal, and to transmit the shutter sync control signal with the predetermined delay time (Δt) to the signal receiver 221 of the shutter glasses 22 for controlling the shutter glasses 22. The predetermined delay time (Δt) is set to compensate for a time difference in operations of the stereoscopic image display device 21 and the shutter glasses 22.

The shutter sync control signal includes an actuating command for actuating the Left and right shutter lenses 31, 32, first setting information 41 for defining actuating cycles (T) of the left and right shutter lenses 31, 32, and second setting information 42 for defining duty cycles (t₁) of alternating operations of the left and right shutter lenses 31, 32 within the actuating cycles (T). In this embodiment, the shutter sync control signal is a digital signal but is not limited in this aspect.

A first pulse 51 illustrated in FIG. 7 represents the actuating command, the duration starting from occurrence of the first pulse 51 to occurrence of a second pulse 52 is defined as a number (m) of actuating cycles (T), and the subsequent pulses after the second pulse 52 represent the second setting information 42. Further details of how the second setting information 42 is decoded to obtain the left and right triggering signals for controlling duty cycles (t₁) of alternating operations of the left and right shutter lenses 31, 32 within the actuating cycles (T) are omitted herein for the sake of brevity.

In step 903, the shutter glasses 22 are configured to decode the shutter sync control signal, and to turn on the left and right shutter lenses 31, 32 in an alternating manner with reference to the actuating command and the first and second setting information 41, 42 such that the duty cycle (t₁) of the left shutter lens 31 corresponds to display of the left-eye image 201 by the stereoscopic image display device 21 and such that the duty cycle (t₁) of the right shutter lens 32 corresponds to display of the right-eye image 202 by the stereoscopic image display device 21. In other words, when the left shutter lens 31 is turned on and the right shutter lens 32 is turned off, the stereoscopic image display device 21 displays the left-eye image 201, and vice versa. In this embodiment, the duty cycle (t₁) is 40% of the actuating cycle (T) and represents duration of the left and right lenses 31, 32 being turned on.

As illustrated in FIG. 9, it should be noted that a transition time (t₂) is presented between the left shutter lens 31 being turned off and the right shutter lens 32 being turned on and vice versa, i.e., the left and right shutter lenses 31, 32 are both turned off during the transition time (t₂). The transition time (t₂) is 10% of the actuating cycle (T) and is synchronized with the overlap time (t₀) when switching between the left-eye and right-eye images 201, 202, thus avoiding the cross-talk effect when switching between the left-eye and right-eye images 201, 202.

To sum up, the active shutter stereoscopic image display system 2 of the present invention provides a system capable of avoiding cross-talk when switching between the left-eye and right-eye images 201, 202. Additionally, content of the shutter sync control signal will vary with the frame sync signal acquired from the video input signal for different stereoscopic image display devices. Consequently, the shutter glasses 22 of the active shutter stereoscopic image display system 2 can be used with various stereoscopic image display devices.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A stereoscopic image display device adapted for use with shutter glasses, the shutter glasses having left and right shutter lenses, the stereoscopic image display device comprising:
a display processor for receiving a video input signal and outputting a video output signal sequence according to a frame sync signal acquired from the video input signal;
a display screen electrically connected to said display processor for receiving the video output signal sequence, the video output signal sequence corresponding to a sequence of left-eye and right-eye images, said display screen displaying the left-eye and right-eye images in an alternating manner;
a signal generator electrically connected to said display processor for receiving the frame sync signal and generating a shutter sync control signal according to the frame sync signal, the shutter sync control signal being for controlling the shutter glasses and including an actuating command for actuating the left and right shutter lenses, first setting information for defining actuating cycles of the left and right shutter lenses, and second setting information for defining duty cycles of alternating operations of the left and right shutter lenses within the actuating cycles; and
a signal transmitter electrically connected to said signal generator for transmitting the shutter sync control signal generated by said signal generator to the shutter glasses.

2. The stereoscopic image display device according to claim 1, further comprising a delay module electrically connected between said signal generator and said signal transmitter, said delay module receiving the shutter sync control signal generated by said signal generator, introducing a predetermined delay time into the shutter sync control signal, and providing the shutter sync control signal with the predetermined delay time to said signal transmitter for transmission to the shutter glasses, the predetermined delay time being set to compensate for a time difference in operations of said display screen and the shutter glasses.

3. The stereoscopic image display device according to claim 1, wherein the shutter sync control signal is a digital signal.

4. Shutter glasses adapted for use with a stereoscopic image display device, the stereoscopic image display device being operable to output a shutter sync control signal that includes an actuating command, first setting information, and second setting information, the shutter glasses comprising:
left and right shutter lenses;
a signal receiver adapted for receiving the shutter sync control signal;
a signal processor electrically connected to said signal receiver for receiving and decoding the shutter sync control signal, operable to generate an actuating signal with reference to the actuating command for actuation of said left and right shutter lenses, and operable to generate left and right triggering signals with reference to the first and second setting information for controlling actuating cycles of said left and right shutter lenses and for controlling duty cycles of alternating operations of said left and right shutter lenses within the actuating cycles; and
a shutter driver electrically connected to said signal processor for receiving the left and right triggering signals and for turning on said left and right shutter lenses in an alternating manner based on the left and right triggering signals, respectively.

5. A method of controlling a stereoscopic image display system including shutter glasses and a stereoscopic image display device used with the shutter glasses, the stereoscopic image display device receiving a video input signal from which a frame sync signal is acquired, the shutter glasses having left and right shutter lenses, the method comprising:
configuring the stereoscopic image display device to display left-eye and right-eye images of the video input signal in an alternating manner according to the frame sync signal;
configuring the stereoscopic image display device to generate a shutter sync control signal according to the frame sync signal, and to transmit the shutter sync control signal to the shutter glasses for controlling the shutter glasses, the shutter sync control signal including an actuating command for actuating the left and right shutter lenses, first setting information for defining actuating cycles of the left and right shutter lenses, and second setting information for defining duty cycles of alternating operations of the left and right shutter lenses within the actuating cycles; and
configuring the shutter glasses to decode the shutter sync control signal, and to turn on the left and right shutter lenses in an alternating manner with reference to the actuating command and the first and second setting information such that the duty cycle of the left shutter lens corresponds to display of the left-eye image by the stereoscopic image display device and such that the duty cycle of the right shutter lens corresponds to display of the right-eye image by the stereoscopic image display device.

6. The method of controlling a stereoscopic image display system as claimed in claim 5, further comprising configuring the stereoscopic image display device to introduce a predetermined delay time into the shutter sync control signal, the shutter sync control signal with the predetermined delay time being transmitted to the shutter glasses, the predetermined delay time being set to compensate for a time difference in operations of the stereoscopic image display device and the shutter glasses.

7. The method of controlling a stereoscopic image display system as claimed in claim 5, wherein the shutter sync control signal is a digital signal.

8. An active shutter stereoscopic image display system comprising:
a stereoscopic image display device including
a display processor for receiving a video input signal and outputting a video output signal sequence according to a frame sync signal acquired from the video input signal,
a display screen electrically connected to said display processor for receiving the video output signal sequence, the video output signal sequence corresponding to a sequence of left-eye and right-eye images, said display screen displaying the left-eye and right-eye images in an alternating manner,
a signal generator electrically connected to said display processor for receiving the frame sync signal and generating a shutter sync control signal according to the frame sync signal, the shutter sync control signal including an actuating command, first setting information, and second setting information, and
a signal transmitter electrically connected to said signal generator for transmitting the shutter sync control signal generated by said signal generator; and
shutter glasses including
left and right shutter lenses,
a signal receiver for receiving the shutter sync control signal from said signal transmitter,
a signal processor electrically connected to said signal receiver for receiving and decoding the shutter sync control signal, operable to generate an actuating signal with reference to the actuating command for actuation of said left and right shutter lenses, and operable to generate left and right triggering signals with reference to the first and second setting information for controlling actuating cycles of said left and right shutter lenses and for controlling duty cycles of alternating operations of said left and right shutter lenses within the actuating cycles, and
a shutter driver electrically connected to said signal processor for receiving the left and right triggering signals and for turning on said left and right shutter lenses in an alternating manner based on the left and right triggering signals, respectively.

9. The active shutter stereoscopic image display system as claimed in claim 8, wherein said stereoscopic image display device further includes a delay module electrically connected between said signal generator and said signal transmitter, said delay module receiving the shutter sync control signal generated by said signal generator, introducing a predetermined delay time into the shutter sync control signal, and providing the shutter sync control signal with the predetermined delay time to said signal transmitter for transmission to said shutter glasses, the predetermined delay time being set to compensate for a time difference in operations of said display screen and said shutter glasses.

10. The active shutter stereoscopic image display system as claimed in claim 8, wherein the shutter sync control signal is a digital signal.
